(19) United States
(12) Patent Application Publication
(10) Pub. No.: US 2024/0220390 A1
(43) Pub. Date: Jul. 4, 2024

(54) TRACING EVENTS FOR A REAL-TIME ROBOTICS CONTROL SYSTEM

(71) Applicant: Intrinsic Innovation LLC, Mountain View, CA (US)

(72) Inventors: Benjamin Bremer, Ottobrunn (DE); Andre Gaschler, Munich (DE)

(21) Appl. No.: 18/538,406

(22) Filed: Dec. 13, 2023

Related U.S. Application Data
(60) Provisional application No. 63/435,947, filed on Dec. 29, 2022.

(51) Int. Cl. G06F 11/34

(52) U.S. Cl. CPC G06F 11/3476; G06F 11/3495

(57) ABSTRACT

Methods, systems, and apparatus, including computer programs encoded on computer storage media, for generating event logs for trace events. The method includes receiving data representing a trigger for generating event entries of a real-time robotics control system. Each real-time thread corresponds to a non-real-time thread, and is communicatively coupled to a data structure allocated in a memory unit for the real-time thread to store event entries. Each real-time thread stores event entries into a corresponding data structure that is allocated for the real-time thread. The event entries are generated when the real-time thread is executed during real time. The stored event entries are provided to a non-real-time thread that corresponds to the real-time thread from a corresponding data structure. Each non-real-time thread processes the event entries to generate an event log for the corresponding real-time thread. The event log represents trace events occurred during operation of the real-time thread.

### CROSS-REFERENCE TO RELATED APPLICATIONS

This application claims priority to U.S. Provisional Application No. 63/435,947, filed on Dec. 29, 2022. The disclosure of the prior application is considered part of and is incorporated by reference in the disclosure of this application.

### BACKGROUND

This specification relates to frameworks for generating and profiling trace events for a real-time robotic control system.

Real-time software control systems are software systems that must execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation. Such real-time software control systems are often used to control physical machines that have high precision and timing requirements. As one example, a workcell of industrial robots can be controlled by a real-time software control system that requires each robot to repeatedly receive commands at a certain frequency, e.g., 1, 10, or 100 kHz. If one of the robots does not receive a command during one of the periodic time windows, the robot can enter a fault state by halting its operation or by automatically executing a recovery procedure to return to a maintenance position. In this specification, a workcell is the physical environment in which a robot will operate. Workcells have particular physical properties, e.g., physical dimensions that impose constraints on how robots can move within the workcell.

Due to such timing requirements, software control systems for physical machines are often implemented by closed software modules that are configured specifically for highly-specialized tasks. For example, a robot that picks components for placement on a printed circuit board can be controlled by a closed software system that controls each of the low-level picking and placing actions.

### SUMMARY

This specification describes tracing events occurring during real-time execution of custom controls, and a system or method is capable of obtaining tracing events occurring in real-time with no data loss, and processing log data including the tracing events to analyze the real-time performance of the custom control. Briefly, the described techniques implement a respective data structure (e.g., a queue) allocated in a memory unit for each real-time thread using a local memory of the real-time thread, and the real-time thread is configured for real-time operations. The memory buffer is configured to ensure that the real time operations are not blocked by transferring tracing events from a real-time thread to a corresponding non-real-time thread. Each queue is configured to receive event data generated during real-time execution from the real-time thread, the queue being implemented at minimal overhead time with no data blocking or pausing. A non-real-time thread corresponding to the real-time thread is configured to periodically read and process event data from the queue to generate a per-thread event log having real-time trace events. The described techniques analyze the per-thread event log to determine real-time performance of the real-time thread. Alternatively, the described techniques can further combine per-thread event logs for different real-time threads to generate a global event log, and analyze the global event log to determine an overall performance of the real-time execution or inter-thread performance in real-time.

The custom control includes custom software for generating instructions to control one or more movable components in an operating environment, and custom hardware for performing actions according to the instructions. The custom software can include user-specified or user-modified computer programs formulated using the high-level programming languages, or machine readable low-level programming languages, or both. The hardware can include one or more processors, accelerators, or circuits to perform operations based on the instructions (matrix reduction, multiplication, Boolean operations, or other suitable operations). The hardware can further include engines or motors to actuate a motion of a robot in a robotic control system, or to instruct a sensor to collect and transmit sensor data.

The operating environment can include a physical environment for a physical robotic control system, where one or more physical robots and corresponding sensors are located within the system. The operating environment can include a virtual environment simulated by one or more processors.

In some implementations, the described techniques are incorporated with a real-time robotics control framework so that real-time events occurring in the real-time robotics control framework during real-time execution can be traced and logged for down streaming analysis. A real-time robotics control framework can provide a unified platform for achieving multiple types of custom real-time control. For example, a user can define a custom real-time control function, in addition to functions or subroutines already stored in the system, to control a robot to traverse a trajectory for achieving one or more goals. The control function can further define an offset of a reference geometry, e.g., a physical surface of a robot or a component. As another example, a real-time robotics control framework can also consider and compensate for deformations by inter-component interactions. In addition, the framework provides mechanisms for bridging, communication, or coordination between the multiple systems, including forwarding control parameters from a robot application system, providing sensor measurements to a real-time robotic control system for use in computing the custom action, and receiving hardware control inputs computed for the custom action from the real-time robotic control system, all while maintaining the tight timing constraints of the real-time robot control system, e.g., at the order of one millisecond.

Particular embodiments of the subject matter described in this specification can be implemented so as to realize one or more of the following advantages.

The described techniques allow a system to analyze, debug, or optimize real-time execution of a custom function or a custom hardware module coupled to a real-time robotics control system. In particular, the described techniques improve the accuracy and reliability for profiling trace events during the real-time execution of one or more functions, programs, or hardware modules because the described techniques can resolve data loss issues that existing techniques tend to suffer. More specifically, the described techniques generate an event log representing a sequence of trace events that have occurred during real-time execution. The event log can be analyzed for debugging errors in computer programs used for real-time control, or for optimizing different steps, procedures, data flows, data structures, or signal transitions so that the real-time performance of the real-time robotics control system is optimized.

The described techniques can further improve the efficiency of a profiling process for trace events. By using particular data structures (e.g., buffers or queues) coupled to real-time threads for controlling real-time operations to store trace events for the threads, the system does not need to allocate memory in run time by calling an allocation function to allocate a block of memory in bytes (e.g., a malloc(*) function in C++), because such an allocation function can block the operation of a library function that invokes the system call (e.g., a syscall(*) function in C++). In addition, the system does not need to allocate an external memory for temporally storing trace events, which further reduces the bandwidth requirement and the time needed for data communication between the threads and external memories.

In addition, the described techniques are real-time safe in a sense that the profiling process, including storing trace events that are generated by real-time threads into local memory units, and processing the stored trace events using non-real-time threads, is performed fast enough to satisfy time constraints for real-time control purposes. For example, the storing process is performed with little or no overhead time, and the trace events are stored in corresponding queues with no blocking or pausing. Furthermore, corresponding non-real-time threads process the stored trace events timely so ideally no event data would be lost. For example, a non-real-time thread can periodically read and process the stored trace events within the real-time constraints for the control system, and such reading and processing does not interrupt the control system performing operations on the fly.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example robotic system including an example tracing subsystem.

FIG. 2 is a diagram representing additional details of an example tracing subsystem.

FIG. 3 illustrates an example event log generated by a tracing subsystem.

FIG. 4 is a flowchart of an example process for generating an event log during real-time execution in a real-time robotics control.

Like reference numbers and designations in the various drawings indicate like elements.

### DETAILED DESCRIPTION

The described techniques generally relate to generating an event log including multiple trace events that have occurred during real-time execution of a real-time robotics control system. A system or a method generating the event log is real-time safe, because the generation process does not interrupt the real-time operations, and is also compatible with the time constraints inherent for real-time control. More specifically, the described techniques implement a data structure (e.g., a queue or a buffer) for a corresponding real-time thread to collect data representing trace events. Once triggered to collect trace events, the queue is configured to store the collected data as event entries with no blocking or pausing. A non-real-time thread corresponding to the real-time thread periodically is configured to read and process the event entries stored in the queue, so that no trace events data are lost.

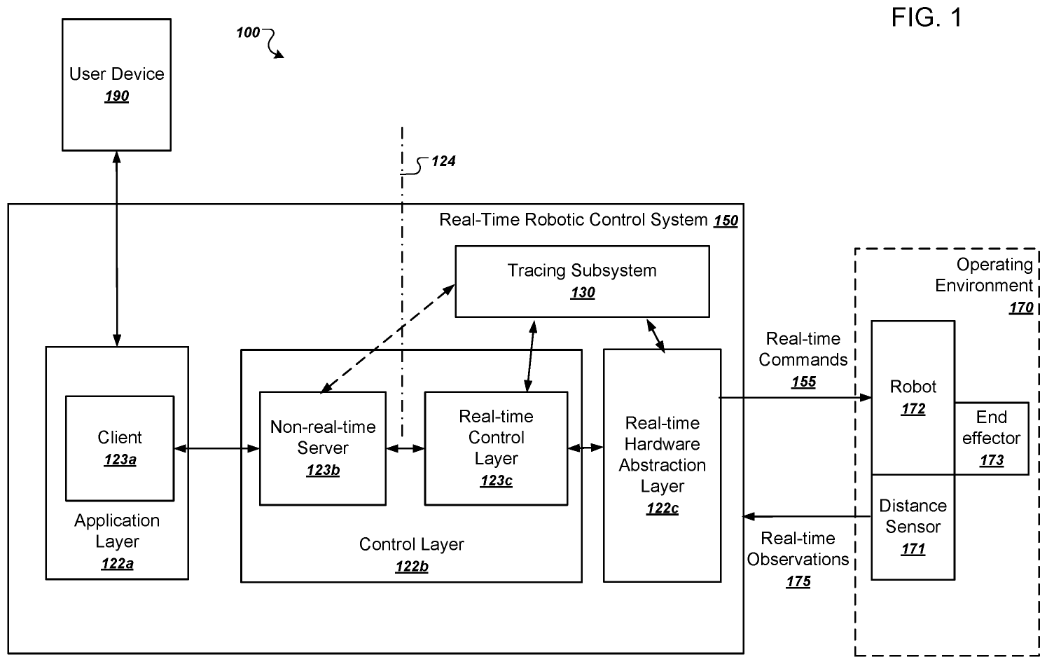

FIG. 1 is a diagram of an example robotic system 100 including an example tracing subsystem 130. The example system 100 is a system implemented on one or more computers in one or more locations, in which systems, components, and techniques described below can be implemented. Some of the components of the system 100 can be implemented as computer programs configured to run on one or more computers. The real-time robotics control system 100 is configured to control operations of one or more components in an operating environment in real time. The tracing subsystem 130 is configured to generate event logs including trace events that have occurred during the real time operation.

The system 100 includes a real-time robotics control system 150 to drive a robot 172 in an operating environment 170. The system 100 allows a user to achieve multiple different types of custom real-time control while simultaneously supporting asynchronous programming or streaming inputs or both. In this specification, a robotic control system being described as being real-time means that it is required to execute within strict timing requirements to achieve normal operation. The timing requirements often specify that certain actions must be executed or outputs must be generated within a particular time window in order for the system to avoid entering a fault state. For brevity, each time window may be referred to as a tick or a control tick. In the fault state, after a tick has elapsed without completing its required computations or actions, the system can halt execution or take some other action that interrupts normal operation, e.g., returning the robots to a starting pose or a fault pose.

Given the robotics control is in real-time and the controls can be user-specified, the system 100 includes particular mechanisms, for the purposes of safety and efficiency, to understand how the real-time control performs, e.g., whether real-time controls are performed in time (within corresponding control ticks), whether the robotics in the operating system performs actions as specified, or whether the user-specifies controls are safe for real-time control, e.g., no potential damages to robots, sensors, or other components in an operating environment, no potential safety concerns for personnel in the vicinity of the operating environment, or other potential issues. The particular mechanisms include generating event data for trace events occurring in real time control, and analyzing the event data to understand, debug, or optimize operations performed by different software, hardware, or other components in the system.

Unlike existing techniques, the system 100 is configured to obtain “intact” trace events for real-time control so that limited to no trace event data would be lost and the real-time control is not paused for processing the collected trace event data. More specifically, the system 100 is configured to store event entries generated by real-time threads for real-time control. The system 100 generally does not lose trace events. However, system 100 is configured to remain real-time compatible if losing one or more trace events is required. To avoid generating incomplete trace events, system 100 does not split events into “start” events and “stop” events, but generates “completion” events. Each “completion” event contains a time stamp and a duration for the trace event, which ensures the trace event being a completed single event. Thus, the described techniques implemented by the system 100 can trace event data without blocking real-time operations and can also reduce or even eliminate trace data loss.

In some implementations, the stored event entries are read and processed by corresponding non-real time threads timely (e.g., satisfying the time constraints for real time control) so that no stored entries would get lost. The system 100 is configured to generate event logs including trace events for real-time threads, and the generated event logs can be transmitted for one or more down-streaming applications or processors for analyzing the performance of custom functions or programs, software and hardware operations, robotic motions, data sensing by sensors, or other suitable performance.

In this specification, real-time control being custom means that a user can specify how robots in a workcell should act or react at each tick of a real-time control cycle. An action refers to a motion having precomputed motion parameters, such as moving a tool on a robot arm from point A to point B. A reaction refers to a real-time switch between actions due to certain specified conditions, which can include sensor data that is updated in real-time. In addition, the system 100 allows users to specify custom real-time control code that is executed to recompute motion parameters on the fly at each tick of the real-time control cycle, as opposed to issuing low-level commands according to precomputed motion parameters.

The system 100 allows users to specify such custom real-time control information with relatively small amounts of user code, which can be expressed in high-level programming languages, e.g., Object Oriented Programming (OOP) languages, including C++, Python, Lua, and Go, to name just a few examples. This capability for providing high-level, custom real-time control is vastly easier and more powerful than programming robot movements using only low-level commands that relate to joint angles or levels of electrical current.

The system 100 can allow users to provide a definition of a custom real-time control function (or code) that can specify, e.g., (i) a trajectory to be followed by the end effector 173 of the robot 172, the trajectory being generated for a representation of a surface in the workcell (e.g., a workpiece surface), and (ii) a distance range within which the end effector 173 of the robot 172 should remain from the surface in the workcell while following the trajectory. For example, a user of the system can define the custom real-time control code for the end effector 173 to remain a particular distance, e.g., 0.5 mm, above the surface in the workcell when performing a task, e.g., a welding or gluing task. The system 100 can collect, in real-time, distance measurements of the end effector 173 relative to the surface using, e.g., the distance sensor 171. Both the actual current distance of the end effector 173 from the surface in the workcell, and the motion parameters for adjusting the distance, can be computed in real-time according to the user's custom real-time control code.

A user of the system 100 can initiate the execution of custom real-time control by providing custom real-time control code to the real-time robotic control system 150. For example, a user can use a user device 190 to provide custom real-time control code to the application layer 122a. The user device 190 can for example execute an integrated development environment (IDE) that is compatible with the real-time robotic control system 150. An IDE is a software suite providing tools facilitating users to write and, optionally, test software for deployment in the real-time robotic control system 150. A user can develop custom software applications in an editor of the IDE. For example, the user can write code, e.g., class, object, or method instances that are required to facilitate the real-time control of the one or more robots to perform a custom action. The system can also prompt the user to write code for different software modules, or different components of a single software module, to be included in the control stack 122. For example, the user interface subsystem 190 can generate a user interface presentation that prompts or guides the user to write code for different class, object, or method instances that, once deployed, constitute the respective software modules included in the control stack 122.

A class is a combination of methods and data that are encapsulated in a file that defines how data are stored and accessed. A class may form a template from which instances of running code may be created or instantiated. An object or code object is code that may be interpreted, compiled, or both. An object may be an example of a class once instantiated for a specific purpose.

The real-time robotic control system 150 can then prepare the custom real-time control code for execution. Different portions of the custom real-time control code can be executed in different layers of the control stack, e.g., in the client 123a, the non-real-time server 123b, the real-time control layer 123c, or some combination of these. A non-real-time server 123b can include one or more non-real-time processors configured to execute one or more non-real-time threads. A real-time control layer 123c can include one or more real-time processors configured to execute one or more real-time threads.

Generally, the control stack of the real-time robotic control system 150 follows a client-server model in which a client 123a provides commands to the non-real-time server 123b, which handles passing commands over a boundary 124 between real-time and non-real-time code. The non-real-time server 123b may execute on a common computer with the client 123a, or operate on a different computer. As described above, this arrangement allows the non-real-time server 123b to implement custom real-time reactions that cause the real-time control layer 123c to switch execution of actions in real time. Thus, the real-time server 123b can be responsible for determining at which control cycle the real-time reaction should occur.

The real-time robotic control system 150 is then configured to control the robot 172 in the operating environment 170 according to the custom real-time control code. The robot 172 can further include an end effector 173, and the real-time robotic control system 150 can control the robot 172 according to the custom real-time control code such that the end effector 173 follows a trajectory in the operating environment 170. To control the robot 172 in the operating environment 170, the real-time robotic control system 150 provides commands, e.g., commands 155, to be executed by one or more robots, e.g., the robot 172, in the operating environment 170. In order to compute the commands 155, the real-time robotic control system 150 consumes observations 175 made by one or more sensors (e.g., a distance sensor 171 and/or any other appropriate sensor) gathering data within the operating environment 170. As illustrated in FIG. 1, the sensor 171 is coupled to the robot 172. However, the sensor need not have a one-to-one correspondence with the robot and need not be coupled to the robot. In fact, the robot 172 can have multiple sensors, and the sensors can be mounted on stationary or movable surfaces in the operating environment 170. Generally, any suitable sensor can be used, such as the distance sensor 171 and/or force sensors, optical sensors, torque sensors, cameras, to name just a few examples.

The real-time robotic control system 150 can provide commands through a control stack 122 that handles providing real-time control commands 155 to the robot 172. The control stack 122 can be implemented as a software stack that is at least partially hardware-agnostic. In other words, in some implementations the software stack can accept, as input, commands generated by the control system 150 without requiring the commands to relate specifically to a particular model of robot or to a particular robotic component.

The control stack 122 includes multiple levels, with each level having one or more corresponding software modules. In FIG. 1, the lowest level is the real-time hardware abstraction layer 122c, and the highest level is the application layer 122a. Some of the software modules 122a-c can be high-level software modules composed of one or more lower-level software modules and a data interface, generated by the user using the lower-level software modules. That is, a custom high-level software module can depend on one or more low-level software modules.

The above-noted real-time threads are configured to, when executed by one or more real-time processors, perform operations on the real-time control side (i.e., right hand side of the boundary 124). For example, one or more real-time threads are executed to perform operations for the real-time control layer 123c. As another example, one or more real-time threads are executed to perform operations associated with the real-time hardware abstraction layer 122c.

Upon initiating the control system 150, the system is configured to allocate memory addresses for queues for one or more real-time threads. Each real-time thread is communicatively coupled to a queue. The queue is used for storing event entries associated with trace events occurring when a corresponding real-time thread is executed in real-time. An example queue can be formulated as a fixed-size queue for storing string-type trace event data.

Trace events described in this specification generally refer to lower level events occurring during real time execution. More specifically, trace events can track lower level operations when executing one or more software programs in real time for the real time control system. The trace events can include data operations (e.g., data access, write, or read), arithmetic operations (e.g., add, multiply, vector or matrix reduction, or Boolean operations), data transmission (e.g., data bus occupancy), resources usage (e.g., memory usage or computation power usage), or other suitable events. In some implementations, trace events can also include hardware events such as robot motions, environment sensing using one or more sensors, control feedbacks, control loops, or other suitable hardware events.

The tracing subsystem 130 is configured to interact with the real-time control layer 123c and the real-time hardware abstraction layer 122c to collect trace events generated during real-time control. The tracing subsystem 130 can include memory units local to real-time threads in real-time layers 123c and 122c. The memory units can be used to allocate one or more data structures such as a queue, a triple buffer, a ring buffer, or generally-shared memory, or other suitable forms to store trace event data generated from the real-time threads. In addition, the tracing subsystem 130 can include non-real-time threads to retrieve trace event data from the data structures (e.g., queues) in corresponding real-time threads included in the real-time layers, such as the controller layer 123c, or the abstraction layer 122c or both. The tracing subsystem 130 is further configured to process these retrieved trace event data using one or more non-real-time threads in a timely fashion so the stored trace event data would not be lost. In some implementations, the tracing subsystem 130 can include one or more non-real-time threads for processing the stored trace event data. Alternatively, the tracing subsystem 130 can be configured to couple the memory units (or data structures allocated in the memory units) local to the real-time threads with non-real-time threads, and control data operations and data communication between real-time threads, the memory units, and non-real-time threads. For simplicity, a memory unit or a data structure allocated in the memory unit for storing the trace events is interchangeably referred to as a queue in this document.

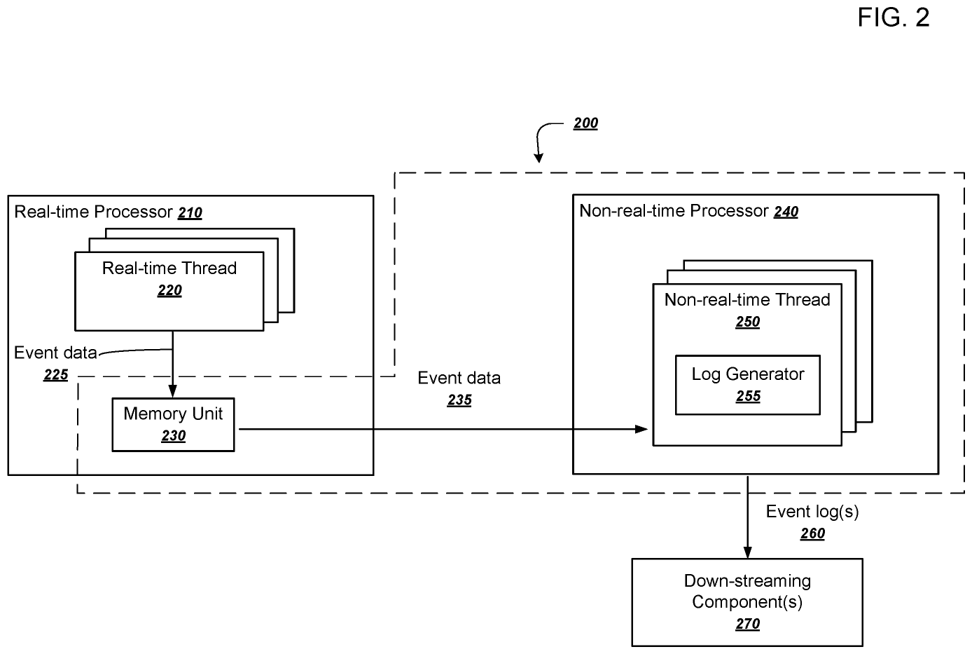

The tracing subsystem 130 can, in some implementations, include one or more real-time threads and further allocate memory from a local memory unit to form data structures (e.g., queues) for storing trace events generated by the real-time threads. For example, the tracing subsystem 130 can include one or more real-time threads in the real-time control stack. The real-time threads generate trace event data while executing one or more computer programs. The generated trace event data are stored in data structures (e.g., queues or buffers) allocated from a memory unit. The tracing subsystem 130 can include one or more non-real-time threads to retrieve the stored trace events from the memory units to generate event logs for downstream analysis. The memory unit can be local to the real-time threads, but in some implementations, the memory unit can be local to the non-real-time threads. More details of the tracing process and the tracing subsystem 130 are described in connection with FIG. 2.

Referring back to the control system 155, the control stack 122 ultimately drives robot components that include devices that carry out low-level actions and sensors that report low-level statuses. For example, robots can include a variety of low-level components including motors, encoders, cameras, drivers, grippers, application-specific sensors, linear or rotary position sensors, and other peripheral devices. As one example, a motor can receive a command 155 indicating an amount of torque that should be applied. In response to receiving the command, the motor can report a status message specifying a current position of a joint of the robot, e.g., using an encoder, to a higher level of the software stack. As another example, the control stack 122 can directly receive observations generated by one or more sensors in the operating environment 170, which may or may not be physically coupled to the robot 172. For example, the observation can include image data generated by an arm-mounted camera or a wall-mounted camera.

Typically, the commands and status messages are generated cyclically during each control cycle, e.g., one status message and one command per control cycle. Lower levels of the software stack generally have tighter time requirements than higher levels of the software stack. At the lowest levels of the software stack, for example, the control cycle can have actual real-time requirements.

In some implementations, the application layer 122a can provide target trajectory information for a robot component. In the case of custom real-time control code, the target trajectory information can be based on status messages generated by other software modules in the control stack 122, real-time observations 175, or both. The trajectory information includes at least a trajectory set point (“goal state”) for a robot component and optionally other metadata. A goal state can include for each moment in a particular time period, one or more of a position, a velocity, or an acceleration for the robot component. The trajectory generated by the application layer 122a may be in Cartesian-space or joint-space coordinates.

The trajectory information can be consumed by the real-time control layer 123c, which use the trajectory information to produce continuous real-time control signals including, e.g., real-time positions, velocities, or torques for a robot component such as a robot joint, which determine how to drive the motors and actuators of the robot 172 in order for the end effector 173 of the robot 172 to follow the target trajectory. The continuous real-time control signals can then be consumed by the hardware abstraction layer 122c. The hardware abstraction layer 122c can include software module that, e.g., a real-time controller module, interfaces the robot 172, e.g., by issuing real-time commands 155 to drive the movements of the moveable components such as joints of the robot 172 in the operating environment 170 to follow the target trajectory.

Real-time controllers generally have parameters that determine how the robot controlled by the controller is driven along the target trajectory. The behavior of the robotic system is hence determined not only by the trajectory information but also the control parameters. Different tasks may require or benefit from different control parameters, and those control parameters may also need to vary during the task for best performance. In this specification, a control parameter is a value that specifies how a real-time controller will cause a robot component to move in order to follow the trajectory.

The specifics of timing constraints and the flexibility related to timing windows are generally configurable aspects of the real-time robotic control system 150 that can be tailored for the task being performed. In an example system, the real-time requirements of the system 150 require that the hardware abstraction layer 122c provide a command at a first rate (or frequency), e.g., every 5, 10, or 20 milliseconds, while the non-real-time requirements of the system 150 specify that the the control layer 122b should provide a command to the hardware abstraction layer 122c at a second rate that is often lower than the first rate, e.g., every 25, 50, or 100 milliseconds. In addition, the rates need not be fixed. For example, the hardware abstraction layer 122c can provide a command at a fixed rate, while the application layer 122a can provide a command at a varying rate or a rate that is sporadic.

To bridge the boundary between the non-real-time commands generated by upper-level software modules in the control stack 122 and the real-time commands generated by the lower-level software modules in the control stack 122, the real-time robotic control system 150 can use the control layer 122b which, in turn, can include both a real-time control layer 123c and a non-real-time server 123b that collectively facilitate real-time control of a custom action from commands issued by the client 123a. The control layer 122b serves as a bridging module in the control stack that translates each non-real-time command into data that can be consumed by real-time controllers that are responsible for generating low-level real-time commands. Such low-level real-time commands can, for example, relate to the actual levels of electrical current to be applied to robot motors and actuators at each point in time in order to effectuate the movements specified by the command. For each custom real-time action, some of all of the constituent software modules of the control layer 122b, including constituent software modules of the real-time control module within the control layer 122b, may be developed by a user. Once developed, the constituent software modules may be provided in the form of one or more application programming interfaces (APIs) and may orchestrate with those within the application module 122b to facilitate custom real-time control of the robot.

Although the tracing subsystem 130 is generally deployed on the right hand side of the real-time control boundary 124 or interacting with the real-time control stack, the tracing subsystem 130 is also robust and compatible for non-real-time controls and threads. For example, the tracing subsystem 130 can store and process data representing trace events that have occurred in operations performed by the non-real-time server 123b. As another example, the tracing subsystem 130 can store and process data representing trace events that have occurred during data communication across the control boundary 124, e.g., control instructions or operations transmitted from non-real-time server 123b to the real-time control layer 123c, or vice versa. More detailed structures and functions of the tracing subsystem 130 are described below in connection with FIG. 2.

FIG. 2 is a diagram representing a detailed structure of an example tracing subsystem 200. The example tracing subsystem 200 is equivalent to the tracing subsystem 130 of FIG. 1.

The idea of the tracing subsystem is for tracing events during real-time execution of a real-time control system. To harmonize the tracing process with real-time control, the generated trace events need to be stored in memory with minimal overhead time and no blocking, and the stored trace events need to be processed timely to avoid data loss. For the purpose of this document, the tracing subsystem 200 can include a memory unit 230. In some implementations, the subsystem 200 can further include one or more real-time threads 220, or one or more non-real-time threads 250, or both.

For example, as shown in FIG. 2, the tracing subsystem 200 can include a memory unit 230, and a non-real-time processor 240 having multiple non-real-time threads 250. The memory unit 230 can be local to the real-time processor 210. The memory unit 230 can allocate one or more memory addresses to form data structures for storing trace events generated by the real-time threads 220. Accordingly, the one or more real-time threads 220 are also referred to as trace event producers). The data structures can include, but are not limited to, a queue, a triple buffer, a ring buffer, or generally-shared memory, or other suitable forms to store trace event data. For simplicity, the following description refers to one or more queues for storing trace event data. The memory unit 230 can generate a respective queue for each of the real-time threads 220. Each queue thus corresponds to a real-time thread 220 executed by a real-time processor 210. Each non-real-time thread corresponds to a queue, and is configured to receive trace event data from the corresponding queue.

In some implementations, the tracing subsystem 200 can include memory unit 230, a real-time processor 210 with multiple real-time threads 220, and a corresponding non-real-time processor 240 with multiple non-real-time threads 250. The one or more real-time threads 220 act as trace event producers to generate trace event data. Queues in the memory unit 230 each store trace event data 225 generated by a corresponding real-time thread 220. One or more non-real-time threads 250 act as trace event consumers for retrieving and processing the event data 235 from the memory unit 230. The event data 235 can represent the save events as the event data 225, but might be differently structured or formulated.

In some implementations, the tracing subsystem 200 can include only queues in the memory unit 230 for storing trace events generated from producers (e.g., real-time threads).

In some implementations, the memory unit 230 can be local to the non-real-time processor 240, and is communicatively coupled with the real-time threads 220 in the real-time processor 210.

The tracing subsystem 200 can be initiated to start tracing events based on a trigger. The tracing subsystem 200 can receive a trigger and determine whether the trigger has a value satisfying an initiation criterion. For example, the trigger can include a Boolean value (e.g., True or False, Start or Stop, or a flag value switching from Zero to One), and the initiation criterion can include that the trigger is set to the value “True,” “Start,” or “One.” The tracing subsystem 200 can stop tracing events once the trigger value satisfies a stopping criterion. For the above example, the stopping criterion can include the trigger being set to the value “False,” “Stop,” or “Zero.” The trigger can have other data types or values, and the trigger criterion and stopping criterion can be assigned with suitable values for corresponding data types.

The real-time processors 210 are configured to execute multiple real-time threads. For example, one real-time processor 210 can execute one or more real-time threads to perform a specific computer program for real-time control. The specific computer program can include at least a portion of custom functions or programs for controlling robotic tasks in an operating environment. The specific computer program can further include executable codes for generating trace events when the real-time processors are executing relevant program portions. For example, the executable codes, once executed, can cause the real-time thread to generate data representing trace events when the real-time threads are performing corresponding arithmetic operations, data operations, or data transmission. The real-time threads generating trace event data are also referred to as trace event producers or producers in this document.

Trace events can have different types. For example, a trace event can include a completion trace event, which takes at least a specific time period to complete. A completion trace event can include a data transfer event from a starting time point to a completion time point. A real-time thread (e.g., the trace event producer) can tag the data transfer event with a starting timestamp and a completing timestamp. Upon the initiation of the data transfer event, the real-time thread generates a first event entry representing the start of the data transfer event associated with the starting timestamp, and upon the completion of the data transfer, the real-time thread generates a second event entry representing the completion of the data transfer event associated with the completion timestamp. The memory unit holds the data representing the completion trace event until the second event entry has been transferred to a corresponding non-real-time thread. This way, the system does not lose stored event data. The tracing subsystem 200 can pair the start and completion timestamps and corresponding two event entries to represent the completion trace event. The real-time thread can destruct the stack memory for completion trace events after the corresponding event entries are stored in corresponding queues.

As another example, a trace event can include an instant trace event, which completes instantly. An instant trace event can include a calling of a function, an output of arithmetic operations, or a termination of a nested loop. A real-time thread can tag an instant trace event with a timestamp that the trace event starts (and completes). Upon the initiation of an instant trace event, the real-time thread generates a first event entry representing the instant trace event and stores the first event entry representing in a queue coupled to the real-time thread.

As another example, a trace event can include a counter event, e.g., using one or more counter registers to accumulate the number of occurrences of a specific event. A real-time thread can tag a counter event with a timestamp each time when a counter register accumulates. The real-time thread generates a first event entry representing a first time a counter value is incremented by a counter register, and generates a second event entry representing a second time the counter value is incremented by a the counter register. The event entries are stored in a corresponding queue coupled to the real-time thread.

In general, each real-time processor 210 is configured to execute one or more real-time threads 220. Each real-time thread 220 can include a queue 230 for storing event entries generated by the corresponding real-time thread 220. Each queue 230 is created using local memories of a corresponding real-time thread 220. In addition, each non-real-time processor 240 is configured to execute one or more non-real-time threads 250. Each non-real-time thread 250 corresponds to a real-time thread 220, and is configured to receive event entries 235 from the queue 230 in the corresponding real-time thread 220. Each non-real-time thread 250 further includes a log generator 255 configured to process the event entries 235 to generate an event log representing multiple trace events for the corresponding real-time thread. The event log generated for a real-time thread is also referred to as a per-thread event log. In some implementations, the non-real-time processor 240 can combine different per-thread event logs for different real-time threads to generate a global event log.

The event logs 260 can include a per-thread event log, or a global event log, or both. The event logs 260 can be used by down-streaming components 270 to analyze the performance of the real-time control. For example, a down-streaming component can analyze a per-thread event log to determine the performance of a real-time thread during the execution of the real-time control, e.g., the performance of arithmetic operations, memory access, or local data operations for the real-time thread. As another example, a down-streaming component can analyze a global event log to determine inter-thread performance or the overall performance of multiple real-time threads. The inter-thread performance can include the performance of data transfer across different real-time threads, data combination across different real-time threads, or other suitable inter-thread operations. By analyzing the event logs 260, the down-streaming components 270 can further debug one or more errors occurring during real-time execution of custom functions or programs, or optimize one or more custom functions for real-time control, or both.

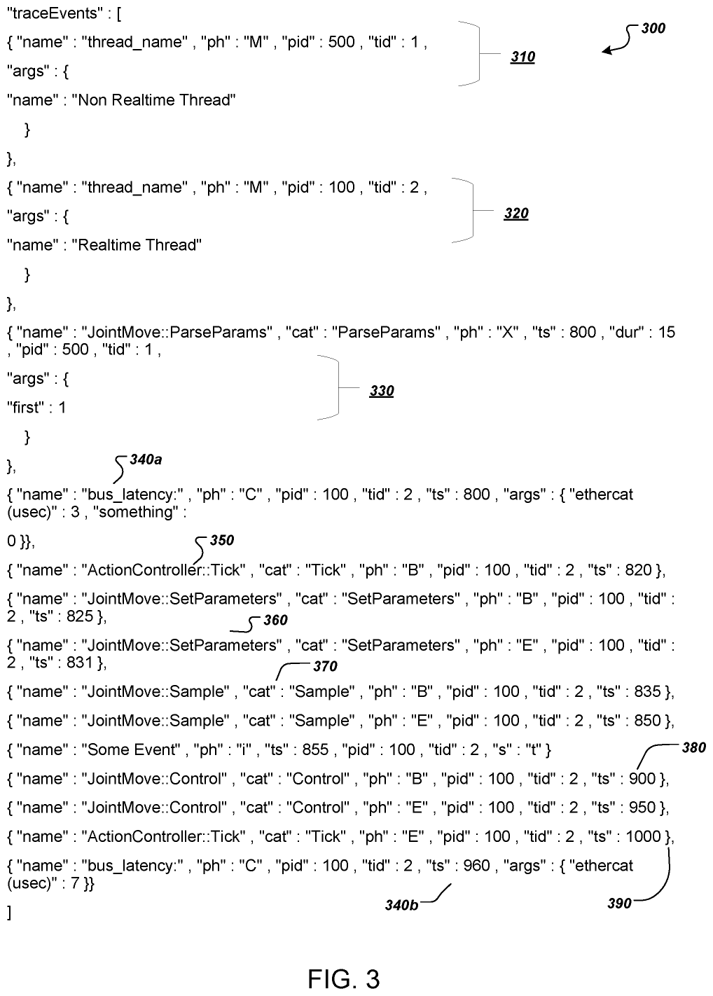

FIG. 3 illustrates an example event log 300 generated by a tracing subsystem. The tracing subsystem can be equivalent to the tracing subsystem 130 of FIG. 1, or the tracing subsystem 200 of FIG. 2.

The event log 300 can be a per-thread event log that includes multiple trace events that have occurred during the real-time execution using a real-time thread. The multiple trace events are recorded using a particular format. The event log 300 can also be a global event log that includes multiple trace events occurring within and across multiple real-time threads during real-time execution.

For example, the event log 300 can include a first entry 320 in a particular format. The first entry 320 can include data indicating which real-time thread from which corresponding trace events are generated. In addition, the first entry 310 includes a name for a thread (e.g., “thread_name”), which is displayed in an user interface or display. The first entry 310 further includes an event type (e.g., “ph”) with a single character change based on the output event type. The first entry 310 includes a tag indicating a Meta data event (e.g., “M”), which further defines the thread name for the trace event. The first entry 310 further includes a process ID (e.g., “pid”) indicating a process that outputs this event and a thread ID (e.g., “tid”) that outputs the trace event. The first entry 310 can further include one or more arguments specified for the trace event (e.g., “args”). Some trace event types can have one or more required argument fields requesting various input information. The arguments can be displayed in the user interface when a trace event is selected during an analysis step. The first entry 310 can further include an argument indicating the thread is a non-real-time thread.

The event log 300 can also include a second entry 320 using the same format. The second entry 320 indicates which non-real-time thread has processed the trace event and generates the instant event log 300 using the trace events. Similarly, the second entry 320 can include a name for a thread (“thread_name”) and other components as described above. The second entry 320 can further include an argument indicating the thread is a real-time thread.

The event log 300 can include one or more trace events. For example, the event log 300 can include a trace event 330 for parsing parameters for moving a joint in a robot. The trace event 300 is formatted to indicate a name for the event, i.e., “JointMove::ParseParams.” The category of the trace event is set to be parsing parameters, i.e., “cat”: “ParseParams.” The JointMove event is indicated as a “X” event (also referred to as completion trace event). The entry 330 can indicate a tracing clock timestamp (e.g., “ts”) of the trace event. The tracing clock timestamp can be provided at microsecond granularity. The entry 330 can further indicate a duration (e.g., “dur”) for completing the event.

In some cases, an entry can further indicate a thread clock timestamp (e.g., “tts”) for a trace event. The thread clock timestamp can be also provided at microsecond granularity.

The trace events include one or more completion trace events, which require a time period to complete. For example, the trace event 330 is a completion trace event as the parsing parameter process requires a time period, e.g., 15 seconds, to complete. In some implementations, the event log can include a pair of trace events indicating a start of the completion trace event and a completion of the completion trace event. The event log 300 includes additional completion trace events such as setting parameters for moving a joint (360), and sampling possible joint motions (370), and controlling the joint motion (380).

The trace events further include one or more instant trace events, which complete instantly. For example, the event log 300 can include a first instant trace event indicating the bus latency for data communication through data buses (340a and 340b). The entry 340a can include custom data added to the trace event using one or more different arguments. As another example, the event log 300 can include a second instant trace event indicating an action of a controller within a control tick (390).

In addition, the list of trace events in the event log 300 can include a counter event. For example, the counter event can be formatted as {“args”: {“k”: 3}, “cat”: value, “id”: value, “name”: “Counter”, “ph”: “C”, “pid”: value, “tid”: value, “ts”: value }.

Although the event log 300 is formatted as shown in FIG. 3, it should be appreciated that the system or the tracing subsystem is configured to generate an event log using other suitable formats or styles different from the example event log 300 in FIG. 3.

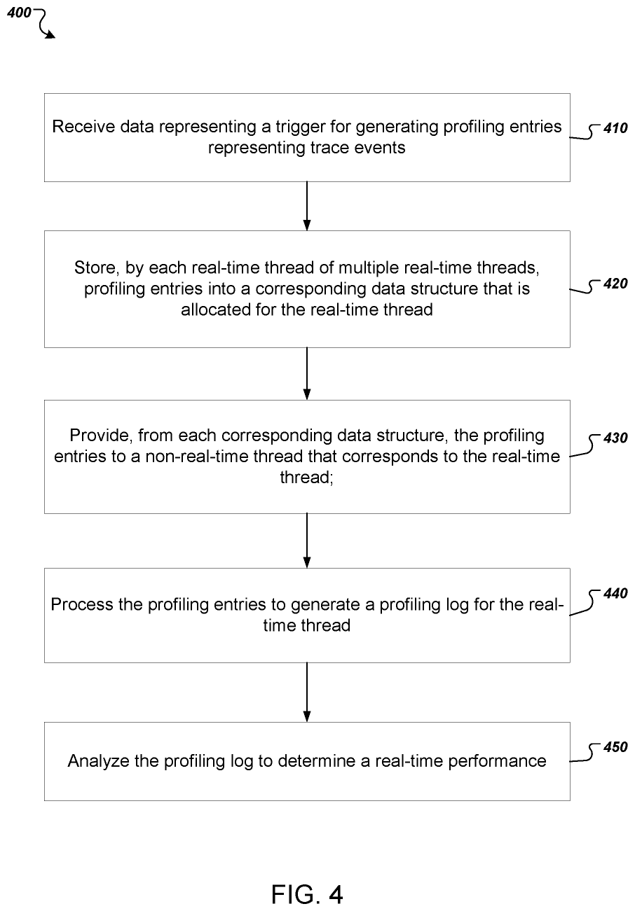

FIG. 4 is a flowchart of an example process 400 for generating an event log during real-time execution in a real-time robotics control. For convenience, the process can be performed by a real-time robotics control system of one or more computers located in one or more locations. For example, a system 100 of FIG. 1 or a tracing subsystem 130 of the system 100, appropriately programmed, can perform the process 400.

The system is configured to generate an event log including multiple trace events that have occurred during real-time control. The generation process is real-time compatible so that no trace event data is lost and the real-time control is not interrupted due to the tracing process.

The system receives data representing a trigger for generating event entries representing trace events that have occurred during real-time operation of a robotics control system (410). As described above, the robotics control system includes one or more non-real- time processors configured to execute one or more non-real-time threads, and one or more real-time processors configured to execute one or more real-time threads with real-time timing constraints. The real-time timing constraints generally refer to generating and transmitting control signals or actions in real-time within each control cycle or control tick so that the controls are real-time accurate and safe. In general, one real-time processor can include multiple real-time threads, and one non-real-time processor can include multiple non-real-time threads. Each real-time thread of the one or more real-time threads corresponds to a non-real-time thread. Each real-time thread can include a queue for storing event entries. Each queue is created based on allocated local memory in the corresponding real-time thread.

In some implementations, the trigger for generating event entries can include a global flag, the global flag being configured to switch from a first value, at which the event entries are not generated, to a second value, at which the event entries are generated. The details of the global flag or trigger are described above in connection with FIG. 2.

The system stores, by each real-time thread of the one or more real-time threads, event entries into a corresponding queue that is allocated for the real-time thread (420). The event entries are generated when the real-time thread is executed during real time. Each event entry is associated with a trace event that has occurred in the real-time thread during real-time execution. Each event entry is also associated with a timestamp indicating a time when the event entry (or the corresponding trace event) occurs. The time is indicated by a timer local to the real-time thread. In general, the system stores event entries into queues coupled to real-time threads in a non-blocking fashion during real time execution.

The system provides, from each queue of the corresponding queues, the event entries that have been stored in the queue to a non-real-time thread that corresponds to the real-time thread having the queue (430). The system can provide the stored event entries to non-real-time threads using one or more data buses. In some implementations, the non-real-time threads each can request data read from a queue coupled to a corresponding real-time thread for the stored event entries. The event entries or trace event data stored in the queue are fetched by corresponding non-real-time threads timely so that no trace event data is lost. For example, the one or more non-real-time threads are configured to periodically read event entries for corresponding queues coupled to corresponding real-time threads.

The system processes, by each non-real-time thread of the corresponding non-real-time threads, the event entries to generate an event log for the real-time thread that corresponds to the non-real-time thread (440). The event log represents trace events that have occurred during real time operation of the real-time thread. The event log generated by a non-real-time thread is generally a per-thread event log, which includes multiple trace events occurring during real-time execution of the corresponding real-time thread.

The system analyzes the event log to determine a real-time performance (450) of the real-time control process. For example, the event log can be processed by a down-streaming component to determine the performance of the one or more real-time threads, or the real-time performance of computer instructions executed by the one or more real-time threads.

In some implementations, the system can combine the event logs of the one or more real-time threads to generate a global event log for the robotic control system. The system can provide the global event log to a down-streaming component for analysis. The down-streaming component can analyze the global event log to determine a real-time performance of the robotic control system. For example, the global event log can be used to determine inter-threads performance during the real-time execution.

The trace events in an event log can include different types of trace events. For example, the trace events can include at least one or more of a completion trace event, an instant trace event, or a counter event. A completion trace event requires a time period to complete an action specified by the completion trace event. The event entries include a pair of event entries associated with the completion trace event. The pair can include a first event entry with a first timestamp representing a start time when the completion trace event is initiated, and a second event entry with a second timestamp representing an end time when the completion trace event is completed. An instant trace event can be completed instantly after it is initiated. The instant trace event can be associated with an event entry with a timestamp when an event occurs or a condition is satisfied. A counter trace event can include an event entry indicating a value tracked by one or more counters (e.g., counter registers).

Moreover, the system is configured to execute the real-time threads in a round robin fashion without rescheduling. The term “round robin fashion” generally refers to a particular way that the system executes each thread of multiple threads. More specifically, the system can execute a first real-time thread of the real-time threads for a predetermined period and switch to execute a second real-time thread of the real-time threads for the same predetermined period, and then repeatedly execute a next thread using the same period. Round robin fashion guarantees that real-time threads are not queued for execution according to a priority or the like. Instead, each real-time thread gets the equal period for execution, and the system cycles through the multiple real-time threads consecutively. In some cases, the system is also configured to execute the non-real-time threads in a round robin fashion without rescheduling.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an operating environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method for generating a event log, comprising receiving data representing a trigger for generating event entries representing trace events that have occurred during real-time operation of a robotics control system, wherein the robotics control system comprises one or more non-real-time processors configured to execute one or more non-real-time threads, and one or more real-time processors configured to execute one or more real-time threads with real-time timing constraints, wherein each real-time thread of the one or more real-time threads corresponds to a non-real-time thread, and is communicatively coupled to a data structure allocated in a memory unit for the real-time thread to store event entries; storing, by each real-time thread of the one or more real-time threads, event entries into a corresponding data structure that is allocated for the real-time thread, the event entries being generated when the real-time thread is executed during real time; providing, from each data structure of the corresponding data structures, the event entries that have been stored in the data structure to a non-real-time thread that corresponds to the real-time thread; and processing, by each non-real-time thread of the corresponding non-real-time threads, the event entries to generate an event log for the real-time thread that corresponds to the non-real-time thread, the event log representing trace events that have occurred during real time operation of the real-time thread.
Embodiment 2 is the method of claim 1, further comprising: analyzing the event log to determine a real-time performance of the execution of the one or more real-time threads or the real-time performance of computer instructions executed by the one or more real-time threads.
Embodiment 3 is the method of claim 1 or 2, wherein the data structure comprises one or more of a queue, a triple buffer, a ring buffer, or generally-shared memory.
Embodiment 4 is the method of any one of claims 1-3, further comprising: combining the event logs of the one or more real-time threads to generate a global event log for the robotic control system, and analyzing the global event log to determine a real-time performance of the robotic control system.
Embodiment 5 is the method of any one of claims 1-4, wherein storing, by each real-time thread of the one or more real-time threads, event entries into the corresponding data structure is not blocked during real time execution.
Embodiment 6 is the method of any one of claims 1-5, wherein the one or more non-real-time threads are configured to periodically read event entries for corresponding data structures in corresponding real-time threads.
Embodiment 7 is the method of any one of claims 1-6, wherein the trace event comprises at least one or more of a completion trace event, an instant trace event, or a counter trace event.
Embodiment 8 is the method of claim 7, wherein the completion trace event comprises a pair of event entries associated with the completion trace event, the pair including a first event entry with a first timestamp representing a start time when the completion trace event is initiated, and a second event entry with a second timestamp representing an end time when the completion trace event is completed.

Embodiment 9 is the method of claim 7, wherein event entries for the instant trace event include an event entry with a timestamp when an event occurs or a condition is satisfied.
Embodiment 10 is the method of claim 7, wherein event entries for the counter trace event include a value tracked by one or more counters.
Embodiment 11 is the method of any one of claims 1-10, wherein the trigger for generating event entries comprises a global flag, the global flag being configured to switch from a first value, at which the event entries are not generated, to a second value, at which the event entries are generated.
Embodiment 12 is the method of any one of claims 1-11, wherein each event entry of the event entries corresponding to a real-time thread is associated with a timestamp according to a time when a corresponding trace event occurs, the time being indicated by a timer local to the real-time thread.
Embodiment 13 is a robotics control system for providing real-time profiling, the system comprising: one or more non-real-time processors configured to execute one or more non-real-time threads; and one or more real-time processors configured to execute one or more real-time threads with real-time timing constraints, wherein the system is configured to allocate a plurality of data structures each for storing trace events generated by a corresponding real-time thread executed by the one or more real-time processors, wherein during real-time operation, each real-time thread is configured to write event entries representing trace events to a respective data structure of the plurality of data structures assigned to the real-time thread, and wherein during real-time operation, each non-real-time thread is configured to read the event entries that have been written to a respective data structure of the plurality of data structures and process the event entries to generate an event log representing the trace events during real-time operation of the robotics control system.
Embodiment 14 is the system of claim 13, wherein the system is configured to execute the real-time threads in a round robin fashion without rescheduling.
Embodiment 15 is one or more non-transitory computer-readable storage media storing instructions that when executed by one or more computers cause the one or more computers to perform respective operations of any one of claims 1-12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method for generating a event log, comprising:
receiving data representing a trigger for generating event entries representing trace events that have occurred during real-time operation of a robotics control system, wherein the robotics control system comprises one or more non-real-time processors configured to execute one or more non-real-time threads, and one or more real-time processors configured to execute one or more real-time threads with real-time timing constraints, wherein each real-time thread of the one or more real-time threads corresponds to a non-real-time thread, and is communicatively coupled to a data structure allocated in a memory unit for the real-time thread to store event entries;
storing, by each real-time thread of the one or more real-time threads, event entries into a corresponding data structure that is allocated for the real-time thread, the event entries being generated when the real-time thread is executed during real time;
providing, from each data structure of the corresponding data structures, the event entries that have been stored in the data structure to a non-real-time thread that corresponds to the real-time thread; and
processing, by each non-real-time thread of the corresponding non-real-time threads, the event entries to generate an event log for the real-time thread that corresponds to the non-real-time thread, the event log representing trace events that have occurred during real time operation of the real-time thread.

2. The method of claim 1, further comprising:
analyzing the event log to determine a real-time performance of the execution of the one or more real-time threads or the real-time performance of computer instructions executed by the one or more real-time threads.

3. The method of claim 1, wherein the data structure comprises one or more of a queue, a triple buffer, a ring buffer, or generally-shared memory.

4. The method of claim 1, further comprising:
combining the event logs of the one or more real-time threads to generate a global event log for the robotic control system, and
analyzing the global event log to determine a real-time performance of the robotic control system.

5. The method of claim 1, wherein storing, by each real-time thread of the one or more real-time threads, event entries into the corresponding data structure is not blocked during real time execution.

6. The method of claim 1, wherein the one or more non-real-time threads are configured to periodically read event entries for corresponding data structures in corresponding real-time threads.

7. The method of claim 1, wherein the trace event comprises at least one or more of a completion trace event, an instant trace event, or a counter trace event.

8. The method of claim 7, wherein the completion trace event comprises a pair of event entries associated with the completion trace event, the pair including a first event entry with a first timestamp representing a start time when the completion trace event is initiated, and a second event entry with a second timestamp representing an end time when the completion trace event is completed.

9. The method of claim 7, wherein event entries for the instant trace event include an event entry with a timestamp when an event occurs or a condition is satisfied.

10. The method of claim 7, wherein event entries for the counter trace event include a value tracked by one or more counters.

11. The method of claim 1, wherein the trigger for generating event entries comprises a global flag, the global flag being configured to switch from a first value, at which the event entries are not generated, to a second value, at which the event entries are generated.

12. The method of claim 1, wherein each event entry of the event entries corresponding to a real-time thread is associated with a timestamp according to a time when a corresponding trace event occurs, the time being indicated by a timer local to the real-time thread.

13. A robotics control system for providing real-time profiling, the system comprising:
one or more non-real-time processors configured to execute one or more non-real-time threads; and
one or more real-time processors configured to execute one or more real-time threads with real-time timing constraints,
wherein the system is configured to allocate a plurality of data structures each for storing trace events generated by a corresponding real-time thread executed by the one or more real-time processors,
wherein during real-time operation, each real-time thread is configured to write event entries representing trace events to a respective data structure of the plurality of data structures assigned to the real-time thread, and
wherein during real-time operation, each non-real-time thread is configured to read the event entries that have been written to a respective data structure of the plurality of data structures and process the event entries to generate an event log representing the trace events during real-time operation of the robotics control system.

14. The robotics control system of claim 13, wherein the system is configured to execute the real-time threads in a round robin fashion without rescheduling.

15. One or more non-transitory computer-readable storage media storing instructions that when executed by one or more computers cause the one or more computers to perform respective operations, the respective operations comprising:
receiving data representing a trigger for generating event entries representing trace events that have occurred during real-time operation of a robotics control system, wherein the robotics control system comprises one or more non-real-time processors configured to execute one or more non-real-time threads, and one or more real-time processors configured to execute one or more real-time threads with real-time timing constraints, wherein each real-time thread of the one or more real-time threads corresponds to a non-real-time thread, and is communicatively coupled to a data structure allocated in a memory unit for the real-time thread to store event entries;
storing, by each real-time thread of the one or more real-time threads, event entries into a corresponding data structure that is allocated for the real-time thread, the event entries being generated when the real-time thread is executed during real time;
providing, from each data structure of the corresponding data structures, the event entries that have been stored in the data structure to a non-real-time thread that corresponds to the real-time thread; and
processing, by each non-real-time thread of the corresponding non-real-time threads, the event entries to generate an event log for the real-time thread that corresponds to the non-real-time thread, the event log representing trace events that have occurred during real time operation of the real-time thread.

16. The one or more non-transitory computer-readable storage media of claim 15, further comprising:
analyzing the event log to determine a real-time performance of the execution of the one or more real-time threads or the real-time performance of computer instructions executed by the one or more real-time threads.

17. The one or more non-transitory computer-readable storage media of claim 15, wherein the data structure comprises one or more of a queue, a triple buffer, a ring buffer, or generally-shared memory.

18. The one or more non-transitory computer-readable storage media of claim 15, further comprising:
combining the event logs of the one or more real-time threads to generate a global event log for the robotic control system, and
analyzing the global event log to determine a real-time performance of the robotic control system.

19. The one or more non-transitory computer-readable storage media of claim 15, wherein storing, by each real-time thread of the one or more real-time threads, event entries into the corresponding data structure is not blocked during real time execution.

20. The one or more non-transitory computer-readable storage media of claim 15, wherein the one or more non-real-time threads are configured to periodically read event entries for corresponding data structures in corresponding real-time threads.
